(19) United States
(12) Patent Application Publication
(10) Pub. No.: US 2025/0065966 A1
(43) Pub. Date: Feb. 27, 2025

(54) Grouser For A Track Shoe

(71) Applicant: ExxonMobil Technology and Engineering Company, Spring, TX (US)

(72) Inventors: Richard W. Leger, Leduc (CA); Boran Tian, Calgary (CA); Devon C. Koroluk, Calgary (CA)

(21) Appl. No.: 18/811,870

(22) Filed: Aug. 22, 2024

Related U.S. Application Data
(60) Provisional application No. 63/520,994, filed on Aug. 22, 2023.

(51) Int. Cl. B62D 55/26

(52) U.S. Cl. CPC B62D 55/26

(57) ABSTRACT

A grouser for a track shoe, the grouser comprising a matrix material and a plurality of embedded inserts. The inserts are arranged in the matrix material to form one or more ice lugs. The inserts have a hardness greater than a hardness of the matrix material, such that use of the grouser on a track shoe will abrade the matrix material at a rate greater than a rate of abrasion of the insert material.

### CROSS-REFERENCE TO RELATED APPLICATION

This application claims the benefit of U.S. Provisional Application Ser. No. 63/520,994, entitled “Grouser For A Track Shoe” filed Aug. 22, 2023, the disclosure of which is hereby incorporated by reference in its entirety.

### FIELD OF THE DISCLOSURE

The disclosure relates generally to track shoes, and more particularly to a grouser for a track shoe.

### DESCRIPTION OF RELATED ART

This section is intended to introduce various aspects of the art, which may be associated with the present disclosure. This discussion is believed to assist in providing a framework to facilitate a better understanding of particular aspects of the present disclosure. Accordingly, it should be understood that this section should be read in this light, and not necessarily as admissions of prior art.

Heavy machinery and equipment are typically constructed to use track shoes with protrusions, called grousers, that improve traction with the ground. Over time, the grousers wear down with use, resulting in lower traction. In addition, some environments or surfaces, such as ice or soft terrain, are more prone to cause track shoe slippage. For this reason, ice lugs (which are not restricted to use on ice) can be welded onto the top of the grousers to provide additional traction.

In the fall, ice lugs are welded to the grousers to provide additional traction for icy surfaces in the winter. The ice lugs wear down with use and become less effective in providing traction over time. Some ice lugs have an estimated lifetime of approximately 500 hours, which means that in some industries, the ice lugs on the grousers must be replaced at least two to four times during the winter season. The repeated refurbishment and/or replacement of the ice lugs for the grousers each year and over the course of the winter season may lead to significant downtime for the machines (i.e., periods of non-use). For example, some machines require approximately one week to replace and/or repair the ice lugs.

Overall, the repeated installation and wearing of ice lugs results in increased costs for welding and accounting for the downtime of machines during the refurbishment. It would be desirable to improve the longevity of the ice lugs and reduce the downtime required to refurbish track shoe grousers with ice lugs.

### SUMMARY

A grouser for a track shoe, the grouser comprising a matrix material and a plurality of embedded inserts. The inserts are arranged in the matrix material to form one or more ice lugs. The inserts have a hardness greater than a hardness of the matrix material, such that use of the grouser on a track shoe will abrade the matrix material at a rate greater than a rate of abrasion of the insert material.

The inserts may have a hardness of at least 900 HV. The plurality of embedded inserts may be vertically oriented in the matrix material. The material may comprise low alloy carbon steel. The plurality of embedded inserts may comprise tungsten carbide or titanium carbide. Each of the inserts may be cylindrical. The inserts may be embedded in the matrix material such that the inserts are uncovered as the matrix material is abraded. The grouser may be manufactured with one or more protrusions containing the plurality of embedded inserts. The protrusions may be welded to the grouser. The protrusions may be composed of the matrix material. The inserts may be arranged in one or more rows in each of the one or more ice lugs. Each of the more ice lugs may comprise two rows of the plurality of embedded inserts, offset from one another. Each of the one or more ice lugs may comprise two rows of the plurality of embedded inserts, aligned with one another.

A method of manufacturing a grouser for a track shoe comprises forming a grouser composed of a matrix material and embedding in the matrix material a plurality of embedded inserts. The inserts are arranged in the matrix material to form one or more ice lugs. The inserts comprise an insert material that has a hardness greater than a hardness of the matrix material, such that use of the grouser on a track shoe will abrade the matrix material at a rate greater than a rate of abrasion of the insert material.

The foregoing has broadly outlined the features of the present disclosure so that the detailed description that follows may be better understood. Additional features will also be described herein.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a schematic of the front view of a grouser that is manufactured with a plurality of vertically embedded inserts.

FIG. 2 is a schematic of the front view of a grouser manufactured with one or more protrusions that form the approximate shape of an ice lug.

FIGS. 3A to 3D are schematics of the top view of a grouser where the inserts are arranged into two rows. FIG. 3A depicts a grouser with one group of inserts, where the insert rows are offset from each other. FIG. 3B depicts a grouser with two groups of inserts, where the insert rows are offset from each other. FIG. 3C depicts a grouser with one group of inserts, where the insert rows are aligned with each other. FIG. 3D depicts a grouser with two groups of inserts, where the insert rows are aligned with each other.

It should be noted that the figures are merely examples and no limitations on the scope of the present disclosure is intended thereby. Further, the figures are generally not drawn to scale, but are drafted for purposes of convenience and clarity in illustrating various aspects of the disclosure.

### DETAILED DESCRIPTION

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

At the outset, for ease of reference, certain terms used in this application and their meaning as used in this context are set forth below. To the extent a term used herein is not defined below, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

Throughout this disclosure, where a range is used, any number between or inclusive of the range is implied.

The terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numeral ranges provided. Accordingly, these terms should be interpreted as indicating that insubstantial or inconsequential modifications or alterations of the subject matter described and are considered to be within the scope of the disclosure.

The articles “the”, “a” and “an” are not necessarily limited to mean only one, but rather are inclusive and open ended so as to include, optionally, multiple such elements.

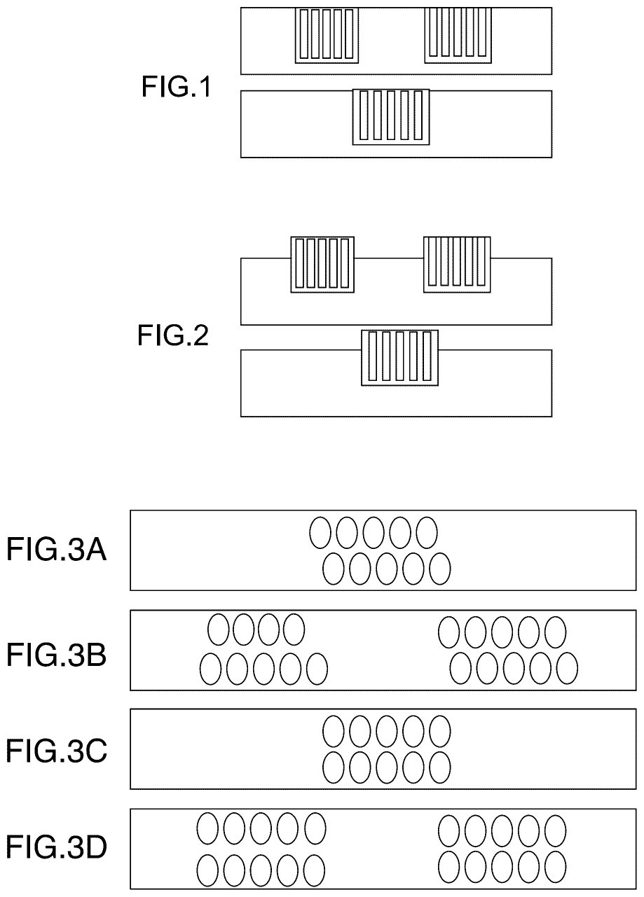

FIG. 1 is a schematic of the front view of a grouser that is manufactured with a plurality of embedded inserts. The inserts may be vertical. By “vertical” we mean only any suitable non-horizontal orientation. The inserts may be, for instance, up to 30 degrees from vertical. The inserts may be arranged into groups to form the approximate shape of an ice lug. The grouser is composed of a matrix material, and the inserts have a greater hardness than the matrix material. When the matrix material abrades from use of the grouser, the inserts are exposed to form an ice lug that improves traction.

An advantage of manufacturing grousers with inserts that are harder than the matrix material may be that no ice lug welding is required. In addition, the matrix material supports the inserts and may reduce potential breakage of the inserts that can occur due to material properties like brittleness and/or the forces acting on the inserts during use. The inserts may be joined to the matrix material by brazing or any other suitable bonding or joining technique.

The inserts may be composed of any suitable material, including a composite metal matrix comprising hard phases of tungsten carbide, titanium carbide, or any suitable material of greater hardness than the matrix material. The inserts may any suitable shape, and may be cylindrical in shape. The inserts may have a hardness of at least 900 HV. Hard phases in the composite material may be higher, for instance, more than 1500 HV. The matrix may be made of any suitable material, and may be low alloy carbon steel.

FIG. 2 is a schematic of the front view of a grouser where the grouser is manufactured with one or more protrusions that form the approximate shape of an ice lug. The inserts may be located in the protrusions to form the ice lugs.

FIGS. 3A to 3D illustrate four schematics of the top view of a grouser where the inserts are arranged into two rows. FIG. 3A depicts a grouser with one group of inserts, where the insert rows are offset from each other. FIG. 3B depicts a grouser with two groups of inserts, where the insert rows are offset from each other. FIG. 3C depicts a grouser with one group of inserts, where the insert rows are aligned with each other. FIG. 3D depicts a grouser with two groups of inserts, where the insert rows are aligned with each other. None of these embodiments are intended to be limiting, and the skilled person would understand that the inserts may be arranged in different configurations, such as in one or more rows, clusters, or any other pattern.

The grouser may be manufactured such that the inserts are partially exposed.

The embedded inserts may be dimensioned to mimic existing ice lugs but being integral to last longer.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

It should be understood that numerous changes, modifications, and alternatives to the preceding disclosure can be made without departing from the scope of the disclosure. The preceding description, therefore, is not meant to limit the scope of the disclosure. Rather, the scope of the disclosure is to be determined only by the appended claims and their equivalents. It is also contemplated that structures and features in the present examples can be altered, rearranged, substituted, deleted, duplicated, combined, or added to each other. The scope of the claims should not be limited by particular embodiments set forth herein, but should be construed in a manner consistent with the specification as a whole

1. A grouser for a track shoe, the grouser comprising:
a matrix material; and
a plurality of embedded inserts;
wherein the plurality of embedded inserts are arranged in the matrix material to form one or more ice lugs;
wherein the plurality of embedded inserts have a hardness greater than a hardness of the matrix material, such that use of the grouser on a track shoe will abrade the matrix material at a rate greater than a rate of abrasion of the insert material.

2. The grouser of claim 1, wherein the plurality of embedded inserts have a hardness of at least 900 HV.

3. The grouser of claim 1, wherein the plurality of embedded inserts are vertically oriented in the matrix material.

4. The grouser of claim 1, wherein the matrix material comprises low alloy carbon steel.

5. The grouser of claim 1, wherein the plurality of embedded inserts comprise tungsten carbide or titanium carbide.

6. The grouser of claim 1, wherein each of the plurality of embedded inserts is cylindrical.

7. The grouser of claim 1, wherein the plurality of embedded inserts are embedded in the matrix material such that the inserts are uncovered as the matrix material is abraded.

8. The grouser of claim 1, wherein the grouser is manufactured with one or more protrusions containing the plurality of embedded inserts.

9. The grouser of claim 8, wherein the protrusions are welded to the grouser.

10. The grouser of claim 8, wherein the protrusions are composed of the matrix material.

11. The grouser of claim 1, wherein the plurality of embedded inserts are arranged in one or more rows in each of the one or more ice lugs.

12. The grouser of claim 11, wherein each of the one or more ice lugs comprises two rows of the plurality of embedded inserts, offset from one another.

13. The grouser of claim 11, wherein each of the one or more ice lugs comprises two rows of the plurality of embedded inserts, aligned with one another.

14. A method of manufacturing a grouser for a track shoe, the method comprising:
forming a grouser composed of a matrix material; and
embedding in the matrix material a plurality of embedded inserts;
wherein the plurality of embedded inserts are arranged in the matrix material to form one or more ice lugs;
wherein the plurality of embedded inserts comprise an insert material that has a hardness greater than a hardness of the matrix material, such that use of the grouser on a track shoe will abrade the matrix material at a rate greater than a rate of abrasion of the insert material.

15. The method of claim 14, wherein the plurality of embedded inserts comprises tungsten carbide or titanium carbide.

16. The method of claim 14, wherein the plurality of embedded inserts are embedded in the matrix material such that the inserts are uncovered as the matrix material is abraded.

17. The method of claim 14, wherein the grouser is manufactured with one or more protrusions containing the plurality of embedded inserts.

18. The method of claim 14, wherein the plurality of embedded inserts are arranged in one or more rows in each of the one or more ice lugs.

19. The method of claim 18, wherein each of the one or more ice lugs comprises two rows of the plurality of embedded inserts, offset from one another.

20. The method of claim 18, wherein each of the one or more ice lugs comprises two rows of the plurality of embedded inserts, aligned with one another.
